(19) United States
(12) Patent Application Publication
(10) Pub. No.: US 2026/0265126 A1
(43) Pub. Date: Sep. 10, 2026

(54) CO2-FREE PRODUCTION OF ARTIFICIAL POZZOLANS, IN PARTICULAR FROM CLAY

(71) Applicants: thyssenkrupp Polysius GmbH, Beckum (DE); thyssenkrupp AG, Essen (DE)

(72) Inventors: Dirk SCHEFER, Ennigerloh (DE); Melanie FLASSPOEHLER, Dortmund (DE); Guido GRUND, Werl (DE)

(73) Assignees: thyssenkrupp Polysius GmbH, Beckum (DE); thyssenkrupp AG, Essen (DE)

(21) Appl. No.: 18/875,445

(22) PCT Filed: Jun. 26, 2023
(86) PCT No.: PCT/EP2023/067228

§ 371 Date: Dec. 16, 2024

(30) Foreign Application Priority Data
Jul. 1, 2022 (BE) BE 2022/5544
Jul. 1, 2022 (DE) 10 2022 206 778.9

(51) Int. Cl. C04B 7/12; F27D 9/00; F27D 11/00; F27D 17/13; F27D 17/17; F27D 17/18

(52) U.S. Cl. CPC C04B 7/12; F27D 9/00; F27D 11/00; F27D 17/13; F27D 17/17; F27D 2009/0075; F27D 17/18; F27M 2003/025

(57) ABSTRACT

A plant for thermally activating fine-particle mineral raw materials for generating artificial pozzolans comprises a drying apparatus, a preheater, and a thermal treatment apparatus, where the fine-particle mineral raw material is conducted from the drying apparatus by way of the preheater to the thermal treatment apparatus, where a gas flow is supplied to the thermal treatment apparatus and supplied from the thermal treatment apparatus to the preheater, characterized in that a first gas flow heater is arranged ahead of the thermal treatment apparatus along the gas flow.

The invention relates to a plant and a method for producing artificial pozzolans, in particular from clays, while avoiding fossil fuels in order to lower emissions of CO₂.

Whereas clinker production involves release of large quantities of CO₂ from lime in the course of the burning, this is not the case for the production of artificial pozzolans from natural clays for usage as a cement substitute. Here, the major quantity of the CO₂ emissions stem from fossil fuels. However, because the processes are designed for gaseous fuels, such as natural gas, or solid fuels, such as coal dust, for example, or else for substitute fuels, it is not easily possible to convert the existing plants to energy from wind or solar. Enabling the utilization of these energy sources requires a radical alteration to the plant construction.
WO 2022/115 721 A2 discloses an energy storage system.
DE 10 2014 102 474 A1 discloses a heating element and a process heater.
DE 10 2021 203 071, DE 10 2021 203 072, DE 10 2021 203 073 and DE 10 2021 203 074 disclose apparatuses and methods for the thermal treatment of a mineral feedstock.
DE 10 2020 211 750 A1 discloses energy recovery in the cooling of color-optimized activated clays.

It is an object of the invention to provide a plant and a method which utilize these new regenerative energy sources for the production of artificial pozzolans as well, so as to avoid emission of CO₂.

This object is achieved by the plant having the features specified in claim 1 and by the method having the features specified in claim 18. Advantageous developments are evident from the dependent claims, the description hereinafter, and the drawings.

The plant of the invention is used for thermally activating fine-particle mineral raw materials and for generating artificial pozzolans. The plant includes a drying apparatus, a preheater and a thermal treatment apparatus. The thermal treatment apparatus may be a calciner or activator, for example. The fine-particle mineral raw material is conducted from the drying apparatus by way of the preheater to the thermal treatment apparatus. The thermal treatment apparatus is supplied with a gas flow in countercurrent, which is supplied from the thermal treatment apparatus to the preheater. Over sections, the solids flow and gas flow may also be conducted preferably in cocurrent and separated again subsequently in a cyclone, for example. Plants of these kinds are known to the skilled person from the prior art—DE 10 2020 211 750 A1 is referenced merely as an illustrative example.

In accordance with the invention, a first gas flow heater is arranged ahead of the thermal treatment apparatus along the gas flow. This distinguishes the plant of the invention fundamentally from a plant according to the prior art. The energy is therefore no longer generated by way of a burner in the thermal treatment apparatus, but is instead imposed by the first gas flow heater on the gas flow supplied to the thermal treatment apparatus, and introduced into the thermal treatment apparatus by way of the gas flow. Hence this for the first time allows the use of regenerative energies, particularly from solar and wind, for the production of artificial pozzolans.

The plant is connected to an apparatus for generating regenerative energy. Examples of an apparatus for generating regenerative energy are solar cell, wind power plant, hydro power station, tidal power station, biomass power station, and the like. Also expressly encompassed, however, is solar thermal energy, for example, where the hot heat transfer medium can also be used directly as heat energy. Particularly in the context of providing electrical energy, preference is given to combined plants—solar cells and wind power, for example—in order to enable better compensation of the reciprocal fluctuations. The connection between the plant and the apparatus for generating regenerative energy may be direct—that is, the apparatus for generating regenerative energy may be an integrated part of the plant. The plant may also be connected to the apparatus for generating regenerative energy by way of a power network, for example.

The plant further includes at least one energy storage apparatus. There may also be two or more different energy storage apparatuses. The energy storage apparatus may be, for example, an accumulator battery for the storage of electrical energy. The energy storage apparatus may be, for example, a storage tank for a heat transfer medium of a solar thermal system. Furthermore, the energy storage apparatus may be a heat store within the plant. It may therefore be advantageous to combine energy storage apparatuses—for example, an accumulator battery and a heat store within the plant.

The plant of the invention affords a further advantage. Since there is no longer any need for combustion, it is also not necessary for the gas flow to include oxygen. As a result, it is also possible to operate with a pure inert gas atmosphere or with a reducing atmosphere for color optimization. Consequently, color optimization may take place during activation itself, in a single step. If a gas other than air is used, it is preferably recirculated.

In a further embodiment of the invention, the fine-particle mineral raw material is a natural clay, pure or as a mixture, a claylike substance, a zeolite, old hydrated cement, or a mixture thereof.

In a further embodiment of the invention, the plant includes at least one apparatus for generating regenerative energy, more particularly a wind power plant or a solar field. With particular preference, the plant includes at least two different apparatuses for generating regenerative energy—for example, a wind power plant and a solar field. Additionally, for example, the plant may also include a biogas plant and a gas turbine, so as to generate electricity CO₂-neutrally from biogas in intervals without sun and wind. This allows for greater flexibility even without large battery systems.

In a further embodiment of the invention, the plant includes at least one first energy storage apparatus. The at least one first energy storage apparatus serves particularly for smoothing out the regeneratively generated energy—thus serving, for example, as day-night compensation for solar electricity. In this case, a large first energy storage apparatus may be provided, configured for supplying all electrically operated plant components. Alternatively, a plurality of smaller energy storage apparatuses may be provided, each supplying individual or a few components of the plant. Energy storage apparatuses which can be used are all known electrical energy storage apparatuses, examples being accumulator batteries and capacitors, but also storage devices which are not purely electrical, such as, for example, a pump storage station or else temporary storage in a chemical product, such as hydrogen, for example (electrolysis/fuel cell combination).

Additionally, the plant may also include a connection to the general electricity network. This not only allows fluctuations to be compensated; in the case of oversupply (and correspondingly low or negative price), electricity can also be used directly or else fed into an energy storage apparatus.

With particular preference, the connection between the generation and/or storage of the regenerative energy comprises not only the first gas flow heater but instead all energy-requiring components, these being, for example, mills, filters, conveyor belts, compressors, and the like.

In a further embodiment of the invention, the first gas flow heater has at least one internal surface. The input of energy into the gas is exclusively by way of the internal surface. The internal surface may be, for example, the surface of a heating wire. The internal surface may also be a metallic surface which is heated electrically from the rear. The internal surface may also be the surface of a body, particularly a tube, which is traversed by a flow of a heat exchange medium. The internal surface may likewise be the surface of a heated heat storage medium—a masonry structure, for example. An internal surface is therefore to be understood as any surface which is arranged in the interior of the first gas flow heater. This distinguishes it fundamentally, indeed, from a burner, where the combustion process provides the energy in the interior of the gas flow and not, indeed, by way of a surface.

In a further embodiment of the invention, the first gas flow heater is a heat exchanger. This embodiment is preferred if the energy is obtained and provided via solar thermal systems, via a salt melt, for example. This allows the thermal energy to be utilized in an optimal way without conversion losses in the case of prior conversion to electricity. Moreover, in such solar thermal plants it is also known practice to store the hot heat exchange medium temporarily, in order in particular to bridge the night and/or sunless days.

In a further embodiment of the invention, the first gas flow heater is an electrical gas flow heater. With particular preference, the gas flow is conducted in only one annular gap around an internal surface which is heated electrically. Comparatively high temperatures which are required for the process can be simply achieved in this way. A heating element in accordance with DE 10 2014 102 474 A1 may be cited as an illustrative example.

In a further embodiment of the invention, the first gas flow heater is implemented as a shell-and-tube heater. The shell-and-tube implementation makes it possible to boost the internal surface area and hence the transfer of heat. At the same time, the reduction in the thickness of the gas layer accelerates diffusion within the gas. Additionally, the external surface area, which irradiates heat and so brings about heat loss and hence a lowering of temperature, is reduced.

In a further embodiment of the invention, the energy storage apparatus is a heat store. The heat store is arranged between the first gas flow heater and the thermal treatment apparatus. The heat store may consist of a large mass traversed by flow. For example, the heat store may consist of masonry. Alternatively, the heat store may consist of metal. The purpose of the heat store in particular is to smooth out temperatures and it is therefore able to compensate temporal fluctuations in the regenerative energy that is generated and hence introduced into the process.

In a further embodiment of the invention, a gas-gas heat exchanger is arranged between the first gas flow heater and the thermal treatment apparatus. In this case, a primary fluid is circulated between the first gas flow heater and the gas-gas heat exchanger. This prevents, for example, introduction of dust into the first gas flow heater. An inert gas, nitrogen or argon for example, may instead be used as the primary fluid, with the additional avoidance of corrosion at the hot locations in the first gas flow heater, for example. With particular preference, the gas-gas heat exchanger is implemented as a countercurrent heat exchanger. The temperature of the primary fluid after the first gas flow heater and the gas-gas heat exchanger may be from 1400° C. to 2000° C., for example.

In a further embodiment of the invention, a second gas flow heater is arranged ahead of the drying apparatus in the gas flow direction. Because of the high enthalpy of vaporization of water, the energy requirement in the drying apparatus is high, and the temperature may remain in a range below 400° C., for example. In other embodiments, however, it may be advantageous to choose a significantly hotter temperature after the second gas flow heater, and so this temperature in particular is more than 9800° C.—for example, 1000° C. to 1200° C. The higher temperature allows a smaller gas flow to be used; because of the moisture content and the resultant evaporation, the solid in the drying apparatus itself is not brought to this temperature. Since, however, the gas flow is intended to provide the entire energy, so as to replace combustion, for example, and hence avoid discharge of CO₂, the gas flow must be adapted in its mass in order to be able to transport the required energy. A targeted second heating in a second gas flow heater is therefore advantageous.

In a further embodiment of the invention, the plant includes a third gas flow heater. The third gas flow heater is in gas-conducting communication with the thermal treatment apparatus. In particular, the third gas flow heater is arranged downstream of the first gas flow heater. For example, the gas supply from the first gas flow heater is arranged at the beginning of the thermal treatment apparatus, and the gas supply from the third gas flow heater approximately in the middle of the thermal treatment apparatus. Consequently, thermal energy can be additionally provided, since in the first part, the gases coming from the first gas flow heater have cooled as a result of the thermal treatment.

In a further embodiment of the invention, the first gas flow heater and an optional third gas flow heater are configured for complete provision of the energy required in the thermal treatment apparatus. The first gas flow heater, indeed, therefore does not serve only to afford a partial quantity; instead, the aim is that the first gas flow heater not only supports a combustion process, but that the gas flow heater in regular operation is capable of covering the entire energy requirement. As an alternative, a heating element may be additionally arranged in the interior of the thermal treatment apparatus. This has benefits and drawbacks. One drawback is the possibility of temperature peaks occurring if a heating element is used in the thermal treatment apparatus, with the possibility in turn of deactivation of the material if certain temperature values are locally exceeded. The use only of the gas flow as an energy supplier, on the other hand, leads to an extremely uniform temperature profile within the thermal treatment apparatus.

In a further embodiment of the invention, the thermal treatment apparatus includes a reserve burner. The purpose of the reserve burner, for example, is to enable emergency operation to be maintained in the event of a dropout in the regenerative energy—for example, to safely run down the plant or to hold it at operating temperature for the purpose of bridging. However, the reserve burner is not intended for regular or sustained operation and is therefore not designed for such operation.

In a further embodiment of the invention, the plant includes a materials cooler. The purpose of the materials cooler is to cool the mineral material and to transfer the thermal energy to a gas flow. The thermal treatment apparatus is in solids-conducting communication with the materials cooler. The materials cooler is in gas-conducting communication with the first gas flow heater, and the first gas flow heater is in gas-conducting communication with the thermal treatment apparatus. As a result, the thermal energy is recovered and the regeneratively generated energy required for heating in the first gas flow heater is reduced.

In a further embodiment of the invention, the plant includes a preliminary materials cooler. The preliminary materials cooler is preferably arranged ahead of the materials cooler along the flow of substance. The materials cooler serves in particular for extremely rapid initial cooling, to a temperature between 400° C. and 500° C., for example. This is preferred if the product has been color-optimized, in a reducing atmosphere, for example, in order to prevent renewed oxidation and hence new coloring of the product. For example, a materials cooler may be a solid-solid cooler, in which the heat is in fact not delivered to a gas flow. A cooling concept of this kind may be found for example in DE 10 2020 211 750 A1.

In a further embodiment of the invention, the plant includes a reducing reactor, more particularly a reducing fluidized-bed reactor. The reducing reactor, more particularly the reducing fluidized-bed reactor, serves typically for color optimization of the product under reducing conditions. The thermal treatment apparatus is in solids-conducting communication with the reducing fluidized-bed reactor, and the reducing fluidized-bed reactor is in solids-conducting communication with the materials cooler.

In a further embodiment of the invention, the first gas flow heater, or the heat store downstream of the first gas flow heater, is in gas-conducting communication with the drying apparatus. A partial gas flow is therefore supplied directly to the drying apparatus.

In a further embodiment of the invention, the preheater or the drying apparatus is in gas-conducting communication with the first gas flow heater. Circulatory routing of this kind is particularly preferred if the operating gas is not air, but instead, in particular, an inert gas or a reducing atmosphere is being used. This allows the valuable gas to be reused.

In a further embodiment of the invention, the thermal treatment apparatus includes a surface heating element. Although this may carry with it the risk of local temperature peaks, it is possible in this way to introduce energy from a regenerative energy source directly into the thermal treatment apparatus and to compensate irradiation losses and so support the reaction, and to smooth the average temperature.

In a further embodiment of the invention, a gas connection is arranged between the materials cooler and the thermal treatment apparatus. This allows comparatively cold gas to be supplied to the thermal treatment apparatus and, through mixing, allows the temperature to be regulated in a simple and very rapid way.

In a further embodiment of the invention, a gas connection is arranged between the materials cooler and the drying apparatus. This allows the heat arising in materials cooling to be used simply and efficiently for the drying.

In a further embodiment of the invention, a gas connection is arranged between the materials cooler and the second gas flow heater. This too allows the heat from materials cooling to be used for the drying.

In a further embodiment of the invention, a gas connection is arranged between the materials cooler and the third gas flow heater.

In a further embodiment of the invention, a gas connection is arranged between the drying apparatus and the first gas flow heater. The water vapor is carried into the system as a result, with the effect in turn of raising the heat capacity, leading in due course to a smaller drop in the temperature within the thermal treatment apparatus.

In a further embodiment of the invention, a gas connection is arranged between the drying apparatus and the third gas flow heater. The water vapor is carried into the system as a result, with the effect in turn of raising the heat capacity, leading in due course to a smaller drop in the temperature within the thermal treatment apparatus.

In a further embodiment of the invention, a dust filter is arranged ahead of the first gas flow heater.

In a further aspect, the invention relates to a method for thermally activating fine-particle mineral raw materials for generating artificial pozzolans, more particularly for a plant of the invention. In a manner customary in the prior art, the flow of material is conducted by way of a preheater and through a thermal treatment apparatus. Essential to the invention is that the gas flow is heated in the first gas flow heater before being supplied to the thermal treatment apparatus. The energy for the process in the thermal treatment apparatus is therefore not generated and provided by combustion in the thermal treatment apparatus, but is instead imposed on the gas flow in the first gas flow heater before entry into the thermal treatment apparatus, and introduced by the gas flow into the thermal treatment apparatus. As a result, it is possible in a simple way to employ regeneratively generated energy entirely and therefore to avoid CO₂ emissions for the generation of energy and so to make the production of artificial pozzolans climate-neutral.

The energy for the first gas flow heater is generated regeneratively, meaning, for example, that electrical or thermal energy is generated from sunlight or wind power. The energy for the first gas flow heater or the heat generated by the first gas flow heater is at least partially stored temporarily in a storage apparatus. The effect of this is to smooth and in particular to compensate the fluctuations in the regenerative energy generated.

In a further embodiment of the invention, in the first gas flow heater, the gas flow is heated to 800° C. to 1800° C., preferably to 800° C. to 1600° C., preferably to 800° C. to 1400° C., preferably to 800° C. to 1200° C., very preferably to 1000° C. to 1200° C.

In a further embodiment of the invention, the fine-particle mineral raw materials selected comprise a natural clay, pure or as a mixture, a claylike substance, a zeolite, old hydrated cement, or a mixture.

In a further embodiment of the invention, the gas is heated in the first gas flow heater by way of an internal surface of the first gas flow heater.

In a further embodiment of the invention, a further gas flow is supplied to the drying apparatus. The further gas flow is heated in a second gas flow heater. The effect of this is that energy at the correct temperature level is available simply and sufficiently for the drying apparatus.

In a further embodiment of the invention, an ancillary gas flow is supplied to the thermal treatment apparatus. The ancillary gas flow is heated in a third gas flow heater. This allows a second gas flow to be supplied, in the middle of the thermal treatment apparatus, for example. As a result, hotter gas can again be supplied there, and hence the thermal activation can be controlled/influenced in a targeted way and/or the temperature profile over the thermal treatment apparatus can be smoothed.

In a further embodiment of the invention, the first gas flow heater and an optional third gas flow heater provide the entire energy required in the thermal treatment apparatus. This means that there is no need for a heating element arranged in the thermal treatment apparatus.

In a further embodiment of the invention, in the event of an energy supply failure and hence failure of the first gas flow heater, a reserve burner is used for generating thermal energy in the thermal treatment apparatus. This allows dropouts to be bridged or safe rundown to be ensured. However, the use of the reserve burner is envisaged only for exceptional situations of these kinds.

In a further embodiment of the invention, the gas flow coming from a materials cooler is heated in the first gas flow heater. As a result, the heat given off by the flow of material can be utilized efficiently and hence also the energy requirement of the first gas flow heater can be reduced.

In a further aspect, the invention relates to a regulatory method wherein the gas temperature emerging from the first gas flow heater is measured, and the gas flow supplied to the first gas flow heater and the electrical energy supplied to the first gas flow heater are regulated as a function of the measured gas temperature. The regulation more preferably is such that the electrical energy available (made up of the currently generated quantity of energy and also, for example, of the residual charge of a battery store) is taken into account. With particular preference, additionally, the quantity of solids supplied to the plant is also regulated as a function of the electrical energy available (made up of the currently generated quantity of energy and also, for example, of the residual charge of a battery store). Where, for example, there is a drop in energy production, as for example at night for a solar plant or during a lull in the wind for a wind power plant, the utilization of the plant is adapted correspondingly.

The plant of the invention is elucidated in more detail below with reference to the exemplary embodiments represented in the drawings.

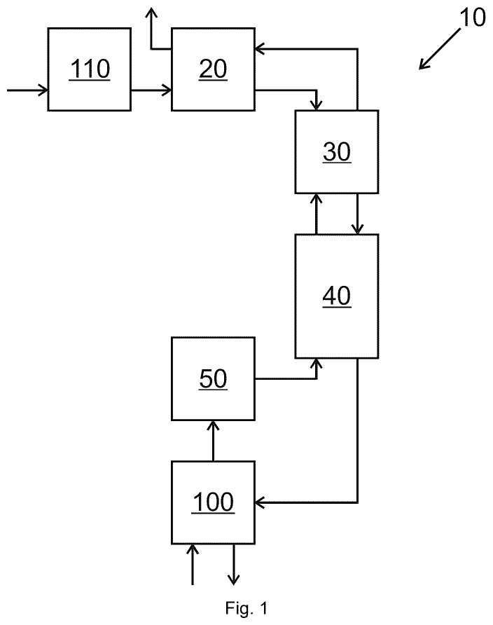

FIG. 1 first illustrative embodiment

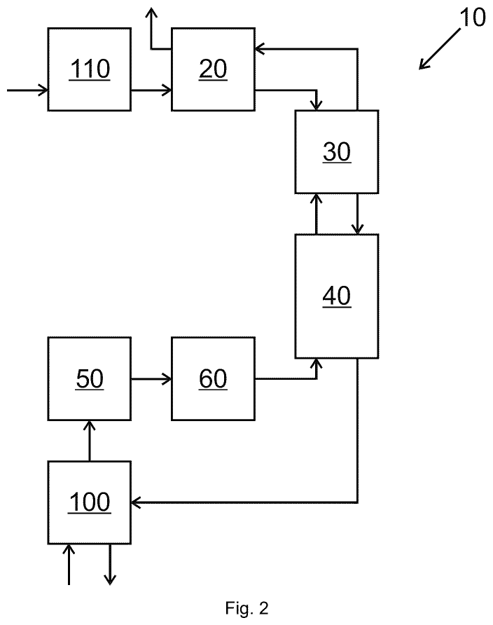

FIG. 2 second illustrative embodiment

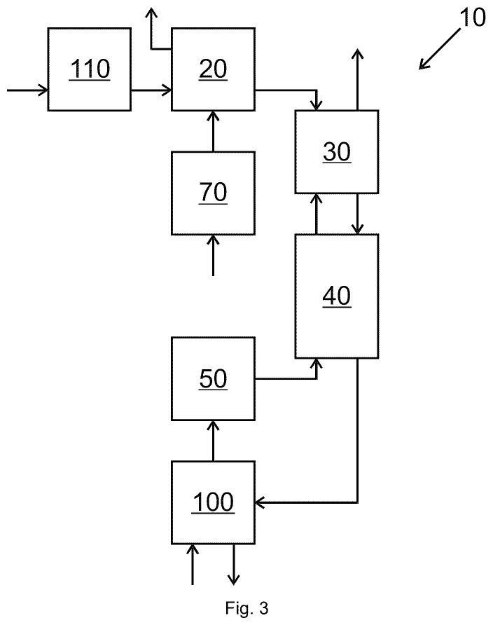

FIG. 3 third illustrative embodiment

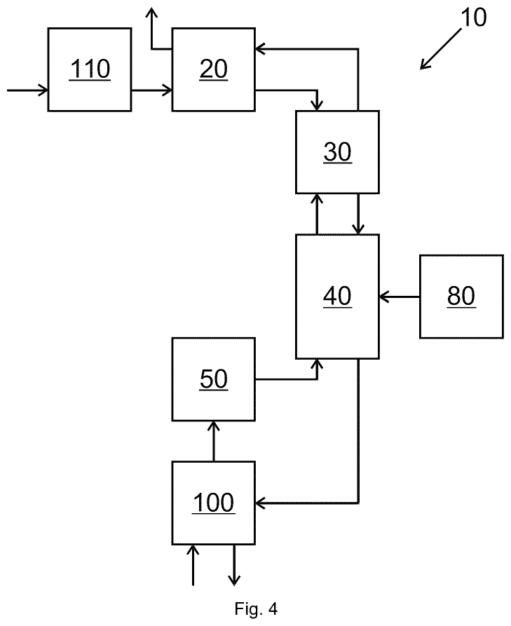

FIG. 4 fourth illustrative embodiment

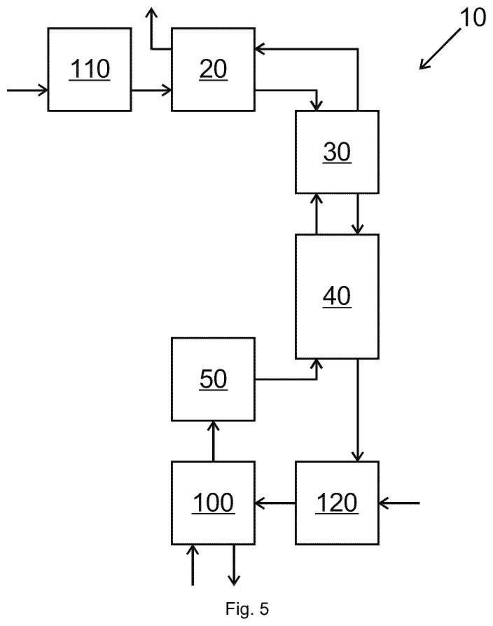

FIG. 5 fifth illustrative embodiment

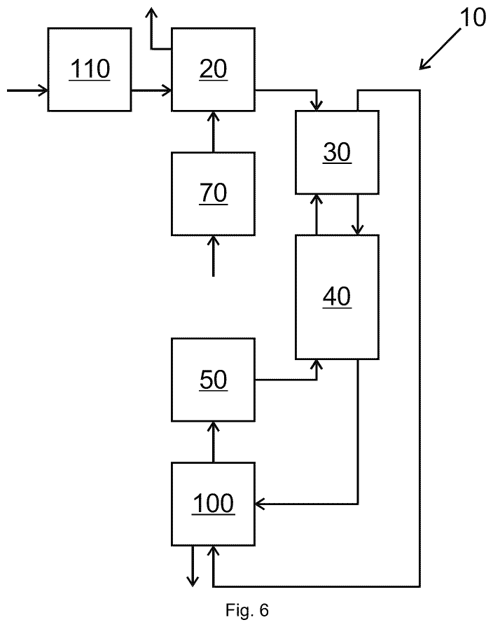

FIG. 6 sixth illustrative embodiment

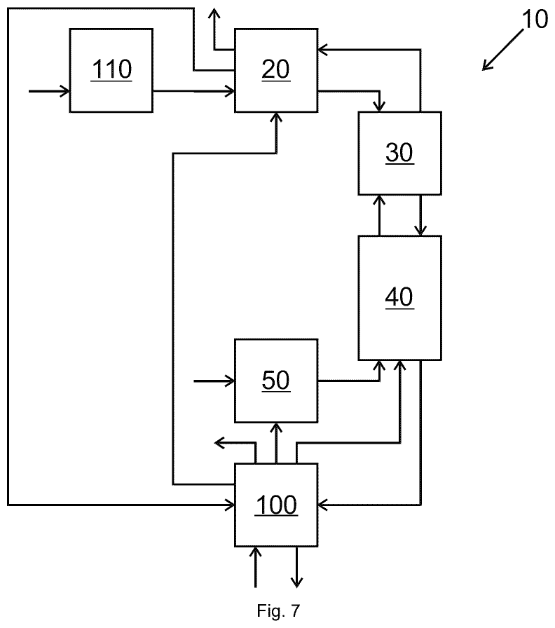

FIG. 7 seventh illustrative embodiment

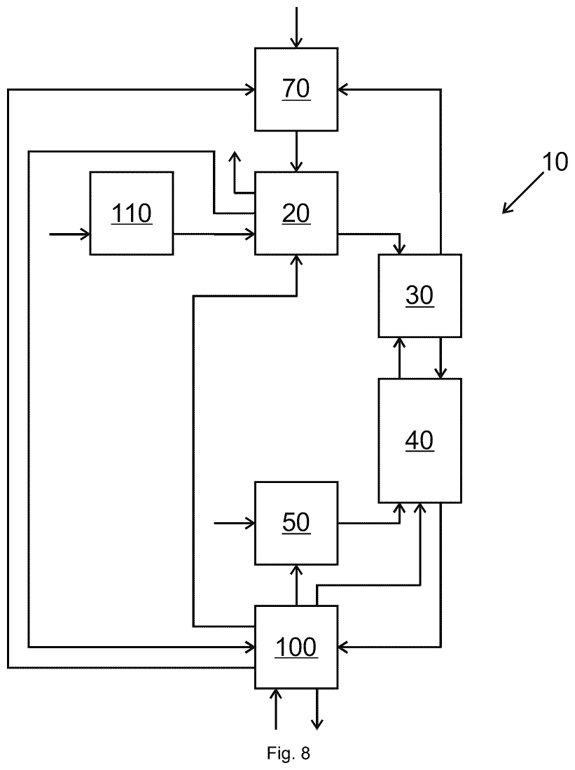

FIG. 8 eighth illustrative embodiment

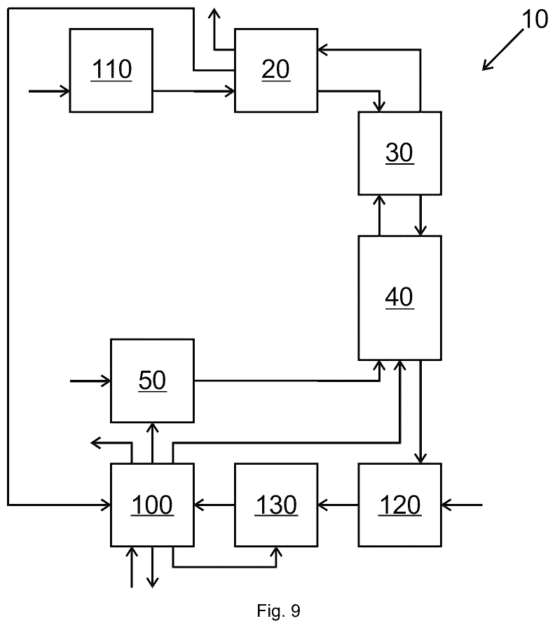

FIG. 9 ninth illustrative embodiment

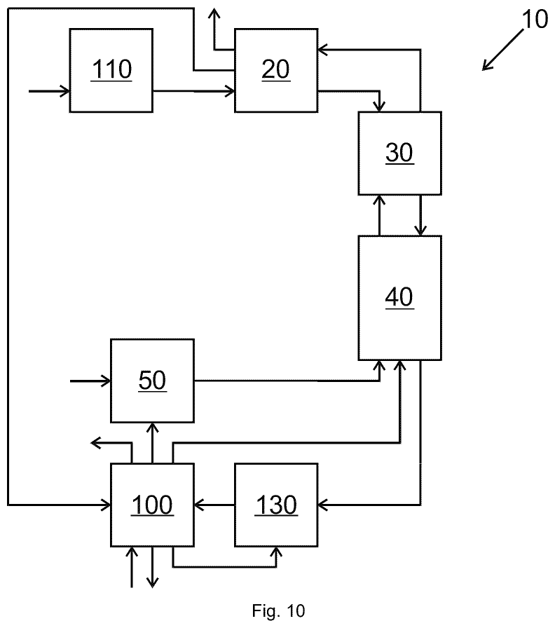

FIG. 10 tenth restrictive embodiment

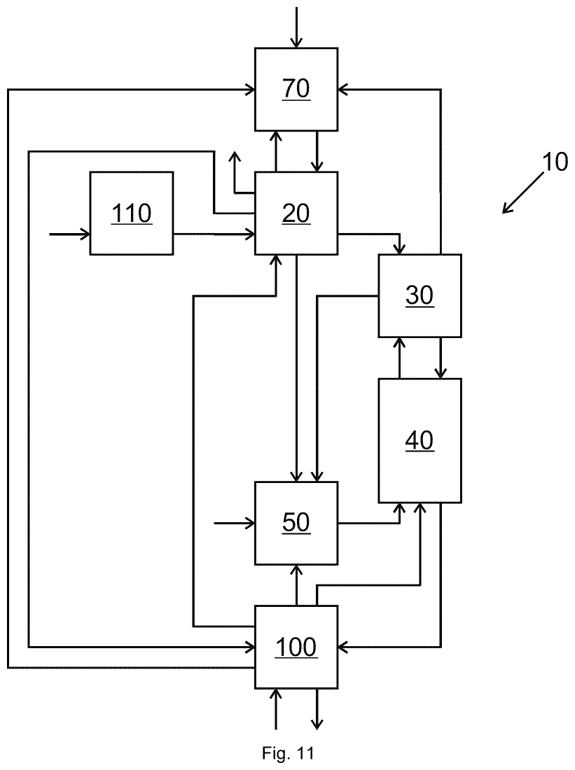

FIG. 11 eleventh illustrative embodiment

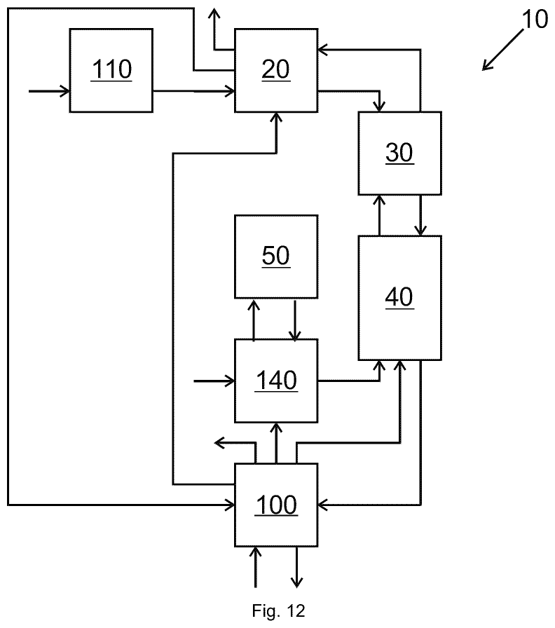

FIG. 12 twelfth illustrative embodiment

To simplify comparability across the various embodiments, identical components are provided hereinafter with identical reference numerals.

FIG. 1 shows a first illustrative embodiment. The plant 10 includes a mill 110, in which, for example, clay as a starting product is ground. From there, the flow of solids is transferred to the drying apparatus 20, where it is dried. From there, the flow of solids is conducted via the preheater 30 into the thermal treatment apparatus 40 and guided subsequently into a materials cooler 100. In the materials cooler 100, the flow of solids is cooled with a gas flow, the gas flow being heated in the process. The preheated gas flow is conducted from the materials cooler 100 into the first gas flow heater 50, where it is heated to 1200° C., for example, in particular by electrical means. For this purpose, with particular preference, power generated regeneratively is used, from a mix of solar and wind power in particular. As a result, there is no need at all for fossil fuels and hence the production of artificial pozzolans can be made climate-neutral. From the first gas flow heater 50, the gas flow is conducted into the thermal treatment apparatus 40, where it provides the energy required for the treatment. The gas flow is subsequently conducted from the thermal treatment apparatus 40 into the preheater and from the preheater 30 into the drying apparatus 20.

In the text below, only the differences between the individual embodiments are addressed.

FIG. 2 shows a second embodiment, where in contrast to the first embodiment, shown in FIG. 1, there is additionally a heat store 60 between the first gas heater 50 and the thermal treatment apparatus 40. This may be a walled region, for example. As a result, there is a smoothing of temperature, although, for example, the regeneratively generated power which is used for the electrical heating in the first gas flow heater 50 exhibits fluctuations.

FIG. 3 shows a third embodiment, where in contrast to the first embodiment, shown in FIG. 1, there is a second gas flow heater 70, which heats a gas flow which is then conducted into the drying apparatus 20. As a result of this, the energy requirement can be adapted in a targeted way via gas flow quantity and temperature to the energy required for the drying. In return, the gas flow from the preheater 30 is discarded. An alternative possibility would be to supply the gas flow from the preheater 30 to the second gas flow heater 70 as well.

FIG. 4 shows a fourth embodiment, where in contrast to the first embodiment, shown in FIG. 1, there is a third gas flow heater 80. The third gas flow heater 80 heats a gas flow which is supplied approximately in the middle into the thermal treatment apparatus 40. Because there is no direct internal heating in the thermal treatment apparatus 40, the energy required for solids conversion is taken from the gas flow, which cools as a result. A hot gas flow is supplied again as a result of the gas flow being supplied from the third gas flow heater 80, and hence the temperature over the thermal treatment apparatus 40 is smoothed.

FIG. 5 shows a fifth embodiment, where in contrast to the first embodiment, shown in FIG. 1, there is a reducing fluidized-bed reactor 120, which is arranged between the thermal treatment apparatus 40 and the materials cooler 100. Color optimization is carried out in the reducing fluidized-bed reactor 120 in a reducing atmosphere-that is, for example, in an atmosphere which includes hydrogen, carbon monoxide, hydrocarbon or a gas mixture including or produced from these substances. For this purpose, the reducing fluidized-bed reactor 120 is supplied accordingly with a suitable reducing agent. The separation of the gas flow from materials cooler 100, thermal treatment apparatus 40 and preheater with an oxygen-containing atmosphere from the reducing atmosphere in the reducing fluidized-bed reactor 120 enables a considerable saving in terms of reducing medium.

FIG. 6 shows a sixth embodiment, where in contrast to the third embodiment, shown in FIG. 3, the gas flow after the preheater 30 is supplied to the materials cooler 100 optionally by way of a cooling apparatus not shown. This makes it possible to employ a reducing atmosphere in the thermal treatment apparatus 40. To be able to separate off gas products emerging from the clay, the gas connection between the preheater 30 and the materials cooler 100 includes a gas flow divider, not shown, to separate off a partial gas flow and so prevent accumulation of the gas products emerging from the clay.

FIG. 7 shows a seventh embodiment, where in contrast to the first embodiment, shown in FIG. 1, there are additional gas connections. Gas connections proceed from the materials cooler 100 to the thermal treatment apparatus 40 and to the drying apparatus 20. In addition, hot air can also be used elsewhere in the plant 10. Furthermore, there is also a return gas connection from the drying apparatus 20 to the materials cooler 100. These additional gas connections can also be correspondingly employed, analogously, for the second to sixth embodiments.

The eighth embodiment, shown in FIG. 8, represents a combination of the third embodiment, shown in FIG. 3, and the seventh embodiment, shown in FIG. 7. A particular feature of the eighth embodiment is the gas connection from the preheater 30 to the second gas flow heater.

The ninth embodiment, shown in FIG. 9, represents a combination of the fifth embodiment, shown in FIG. 5, and the seventh embodiment, shown in FIG. 7. A particular feature is the preliminary materials cooler 130. This cooler 130 receives a cold flow of material from the materials cooler 100, hence allowing the temperature to be rapidly lowered efficiently, via a solid-solid heat transfer, and coloring to be prevented. A preliminary materials cooler 130 of this kind may be found for example in DE 10 2020 211 750 A1.

FIG. 10 shows a tenth embodiment, which differs from the ninth embodiment, shown in FIG. 9, in that it does not include a reducing fluidized-bed reactor 120. Instead, the treatment in the thermal treatment apparatus 40 takes place already in a reducing atmosphere, meaning that in particular the gas connection from the drying apparatus 20 to the materials cooler 100 is important. In a further alternative embodiment, additionally to or instead of this gas connection, a gas connection may be arranged between the preheater and the materials cooler 100 and/or the first gas flow heater, to allow the reducing atmosphere to be circulated.

The eleventh embodiment, shown in FIG. 11, differs from the eighth embodiment, shown in FIG. 8, in additional gas connections from the preheater 30 to the first gas flow heater 50 and also from the drying apparatus 20 to the first gas flow heater 50. A further gas connection, additionally, is arranged between the drying apparatus 20 and the second gas flow heater 70.

The twelfth embodiment, shown in FIG. 12, differs from the seventh embodiment, shown in FIG. 7, in that the first gas flow heater 50, rather than being arranged directly in the gas flow, is instead arranged in a circuit containing a gas-gas heat exchanger 140, so that the heating surfaces in the first gas flow heater 50 do not come into contact with dust or corrosive gas compounds. The lifetime of the first gas flow heater can be extended as a result. With particular preference, the gas-gas heat exchanger is configured as a countercurrent heat exchanger.

### REFERENCE NUMERALS

10 plant
20 drying apparatus
30 preheater
40 thermal treatment apparatus
50 first gas flow heater
60 heat store
70 second gas flow heater
80 third gas flow heater
100 materials cooler
110 mill
120 reducing fluidized-bed reactor
130 preliminary materials cooler
140 gas-gas heat exchanger

1-26. (canceled)

27. A method for thermally activating fine-particle mineral raw materials for generating artificial pozzolans, comprising:
conducting a flow of material by way of a preheater and through a thermal treatment apparatus;
heating the gas flow in the first gas flow heater before the gas flow is supplied to the thermal treatment apparatus; and
generating energy for the first gas flow heater regeneratively;
wherein energy for the first gas flow heater or the heat generated by the first gas flow heater is at least partially stored temporarily in a storage apparatus;
wherein in the first gas flow heater, the gas flow is heated to 800° C. to 1800° C.

28. The method as claimed in claim 27, wherein in the first gas flow heater, the gas flow is heated to 1000° C. to 1200° C.

29. The method as claimed in claim 27, wherein the gas in the first gas flow heater is heated by way of an internal surface of the first gas flow heater.

30. The method as claimed in claim 27, wherein a further gas flow is supplied to the drying apparatus, the further gas flow being heated in a second gas flow heater.

31. The method as claimed in claim 27, wherein an ancillary gas flow is supplied to the thermal treatment apparatus, the ancillary gas flow being heated in a third gas flow heater.

32. The method as claimed in claim 27, wherein the first gas flow heater and an optional third gas flow heater provide the entire energy required in the thermal treatment apparatus.

33. The method as claimed in claim 27, wherein the gas flow coming from a materials cooler is heated in the first gas flow heater.

34. A plant for thermally activating fine-particle mineral raw materials for generating artificial pozzolans, comprising:
a drying apparatus;
a preheater; and
a thermal treatment apparatus;
where the fine-particle mineral raw material is conducted from the drying apparatus by way of the preheater to the thermal treatment apparatus,
where a gas flow is supplied to the thermal treatment apparatus and supplied from the thermal treatment apparatus to the preheater,
wherein a first gas flow heater is arranged ahead of the thermal treatment apparatus along the gas flow, the plant being connected to an apparatus for generating regenerative energy, and the plant including an energy storage apparatus.

35. The plant as claimed in claim 34, wherein the first gas flow heater has at least one internal surface, the input of energy into the gas taking place exclusively by way of the internal surface.

36. The plant as claimed in claim 34, wherein the first gas flow heater is a heat exchanger.

37. The plant as claimed in claim 34, wherein the first gas flow heater is an electrical gas flow heater.

38. The plant as claimed in claim 34, wherein the first gas flow heater is implemented as a shell-and-tube heater.

39. The plant as claimed in claim 34, wherein the energy storage apparatus is a heat store, the heat store being arranged between the first gas flow heater and the thermal treatment apparatus.

40. The plant as claimed in claim 34, wherein a gas-gas heat exchanger is arranged between the first gas flow heater and the thermal treatment apparatus.

41. The plant as claimed in claim 34, wherein a second gas flow heater is arranged ahead of the drying apparatus in gas flow direction.

42. The plant as claimed in claim 34, wherein the plant includes a third gas flow heater, the third gas flow heater being in gas-conducting communication with the thermal treatment apparatus.

43. The plant as claimed in claim 34, wherein the first gas flow heater and an optional third gas flow heater are configured for complete provision of the energy required in the thermal treatment apparatus.

44. The plant as claimed in claim 34, wherein the plant includes a materials cooler, the thermal treatment apparatus being in solids-conducting communication with the materials cooler, the materials cooler being in gas-conducting communication with the first gas flow heater, and the first gas flow heater being in gas-conducting communication with the thermal treatment apparatus.

45. The plant as claimed in claim 34, wherein the first gas flow heater or the heat store downstream of the first gas flow heater is in gas-conducting communication with the drying apparatus.

46. The plant as claimed in claim 34, wherein the preheater or the drying apparatus is in gas-conducting communication with the first gas flow heater.
